(19) United States
(12) Patent Application Publication
(10) Pub. No.: US 2012/0203751 A1
(43) Pub. Date: Aug. 9, 2012

(54) Capture, Aggregate, and Use Search Activities as a Source of Social Data Within an Enterprise

(75) Inventors: Dhanashree Srivastava, Pune (IN); Amy Delphine Travis, Arlington, MA (US)

(73) Assignee: INTERNATIONAL BUSINESS MACHINES CORPORATION, Armonk, NY (US)

(21) Appl. No.: 13/022,119

(22) Filed: Feb. 7, 2011

(51) Int. Cl. G06F 17/30

(52) U.S. Cl. 707/706; 707/722; 707/E17.108

(57) ABSTRACT

An approach is provided with a search request including search terms and a user identified as a member of a common group. A search engine receives search results based on the search request and as set of previously searched data corresponding to the group of users by comparing with the search terms. The comparison results in refined search results that are displayed. A further approach is provided with a search request with search terms being compared against group historical search data to identify historical search terms as well as historical search actions. A search action request corresponding to one of the historical actions is received and executed by the information handling system.

### BACKGROUND

The present invention relates to using group data, such as from a social group or enterprise, to enhance search activities.

Currently, the term “social data” is used to encompass specific user interactions with a page. This includes activities like tagging, rating, book-marking, commenting on or sharing a web-page with fellow users. Content recommendation systems utilize this aggregated social data, run analytics on top of it and recommend or surface relevant content to all users who may be interested in similar terms or concepts. The drawback to this approach is that this social data depends on explicit user interactions with a web page. Often, few people rate or tag a page even if they find it useful. Furthermore, unless a user interacts with the page, a page is not brought under the “social data” umbrella, thereby resulting in loss of valuable content.

### BRIEF SUMMARY

According to one embodiment of the present invention, an approach is provided in which a search request is received from a user of an information handling system. The search request includes one or more search terms of interest to the user. The user is identified as a member of a common group of users with the common group of users being a subset of a search engine community. The search engine receives search results based on the received search request. Previously captured search data that corresponds to the common group of users is compared with at least one of the search terms received from the user. The comparison resulting in a refined set of search results which are displayed to the user on a display device. A further approach is provided in which a search request with one or more terms is received from the user. Group historical search data is identified that includes group historical search terms previously entered by members of the common group as well as group historical search actions that were previously requested by the common group members. The received search terms are compared with the group historical search terms to identify related group historical search actions that are then displayed on the display device. A search action request corresponding to one of the displayed group historical actions is received and executed by the information handling system.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE SEVERAL VIEWS OF THE DRAWINGS

The present invention may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a diagram showing flows between activities used to search content using group-specific search facets;

FIG. 4 is a sample screenshot showing search results returned along with group-specific search activities;

FIG. 5 is a flowchart showing steps taken to provide enhanced search results utilizing group-specific data;

FIG. 6 is a flowchart showing steps taken by a search engine process to utilize group-specific data;

FIG. 7 is a flowchart showing steps performed in order to show a user search activities performed by other members of a group; and

FIG. 8 is a flowchart showing steps performed in order to show a user search activities previously performed by the user.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

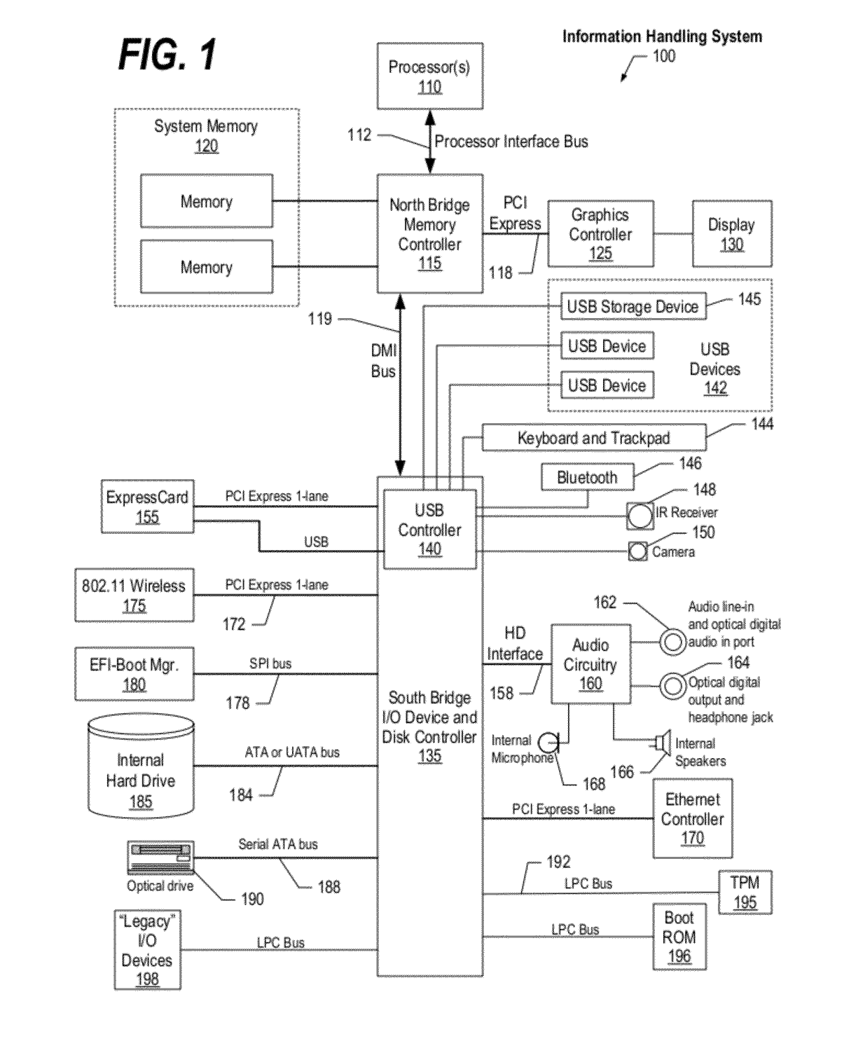

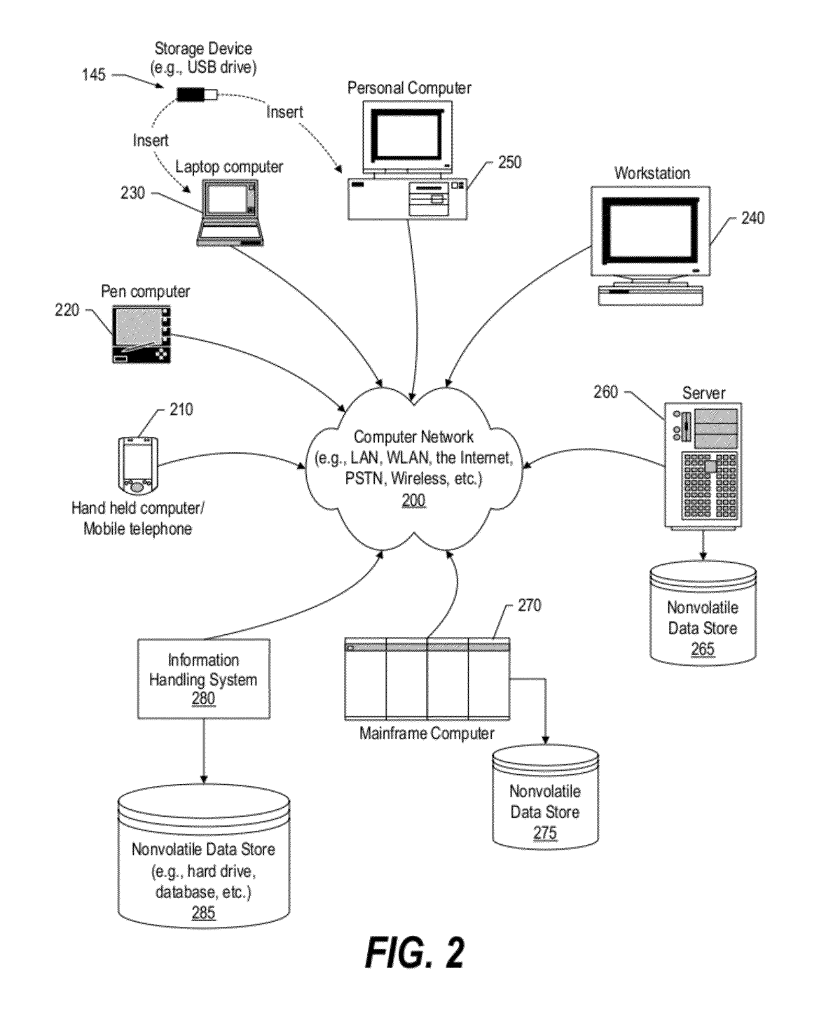

The following detailed description will generally follow the summary of the invention, as set forth above, further explaining and expanding the definitions of the various aspects and embodiments of the invention as necessary. To this end, this detailed description first sets forth a computing environment in FIG. 1 that is suitable to implement the software and/or hardware techniques associated with the invention. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

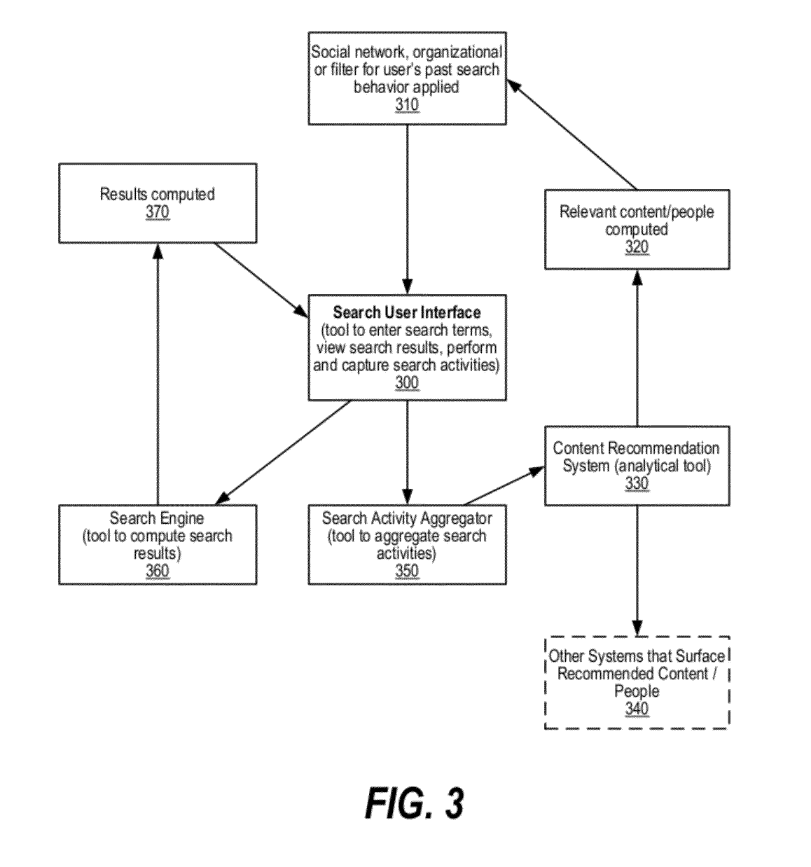

FIG. 3 is a diagram showing flows between activities used to search content using group-specific search facets. Process 300 provides a search user interface (UI) which is a dialog that allows a user to enter search terms, view search results, perform and captures search activities. The user is a member of common group 310 which can be a social network, organization, or filter that is used to enhance the user's past search behaviors and actions. Process 320 computes relevant content and people that is included by common group 310. Note that the user can be a member of several different groups and can choose a group based on the context of the search being performed by the user. For example, a computer programmer may select a group of co-workers (other programmers) or a group established for like-minded individuals (e.g., application programmers, etc.) when executing work-related searches, but may select a social group, such as a club or social organization, when requesting searches related to the social (non-work) group.

Content recommendation system 330 recommends content to the user by highlighting search results either returned from a search engine or previously performed by other members of the selected group or previously performed by the individual user. Highlighting of search results can include “surfacing” search results so that results that are deemed more relevant visually appear before those results that are deemed less relevant. Highlighting can also include displaying previously selected links (by members of the group or by the individual user) as well as displaying additional search facets that allow the user to drill-down into the search results (e.g., narrow the search results by a search term previously found useful by other members of the group or by the individual user, etc.). Search activity aggregator 350 is a tool that aggregates search activities performed by various members of the selected group as well as by the individual user. Note that the system can also integrate with other systems 340 that highlight, or surface, recommended content or people. Search engine 360 is a network-based software tool used to compute search results based upon the user's requested search terms. The search engine computes results 370 that are fed into search user interface 300 for viewing and action by the user.

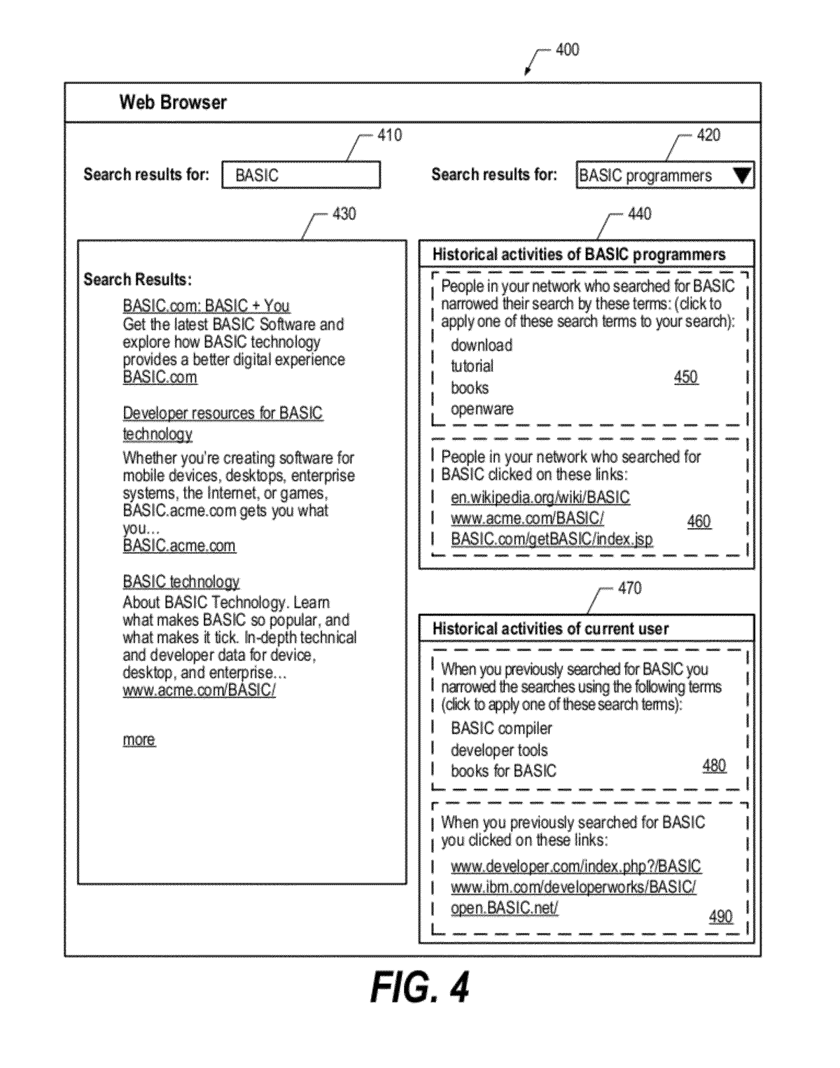

FIG. 4 is a sample screenshot showing search results returned along with group-specific search activities. Webpage 400 is shown with a search user interface used to provide enhanced search results. Search term textbox 410 is a textbox into which the user enters one or more search terms. In the example shown, the user is searching for the term “BASIC” which has various meanings and contexts. However, in group combo box 420 the user has selected a “BASIC programmers” group providing the context and group for search activities to be directed at a group of BASIC programmers. In this manner, the search term “BASIC” has a context applied of being a computer programming language term rather than another context for the term “basic.” Window 430 shows a set of search results for the search term “BASIC”. Note that because the user's group is a set of BASIC programmers, the search results returned and displayed in window 430 are directed to the BASIC programming language and not to a different context of the term “basic.” Results are highlighted (“surfaced”) in window 430 that apply to the BASIC programming language. Window 440 provides group-related highlights for the searched term “BASIC.” Sub-window 450 shows facets (narrowing terms) that were found to have been used by other members of the BASIC programmers group when they previously searched for the term “BASIC.” Sub-window 460 shows links that other members of the BASIC programmers group previously selected when they previously searched for the term “BASIC.” Window 470 provides user-related highlights for the searched term “BASIC.” Sub-window 480 shows facets (narrowing terms) that were found to have been previously used by the current user when he/she previously searched for the term “BASIC.” Sub-window 490 shows links that the current user previously selected when he/she previously searched for the term “BASIC.”

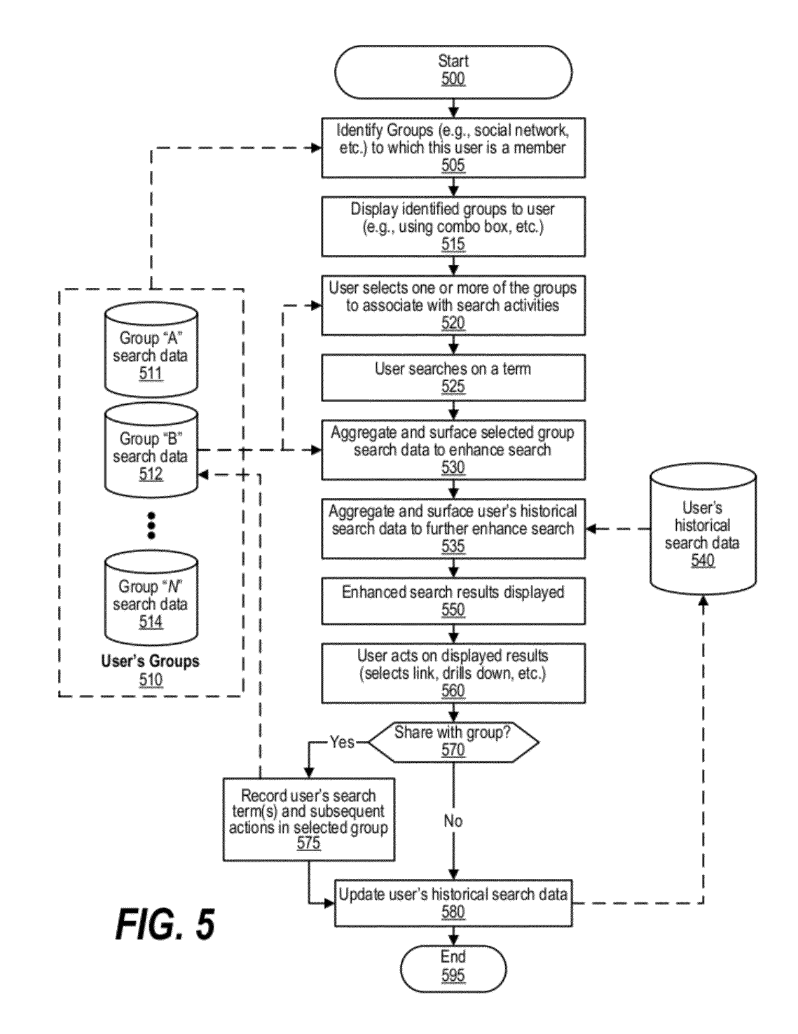

FIG. 5 is a flowchart showing steps taken to provide enhanced search results utilizing group-specific data. Processing commences at 500 whereupon, at step 505, various groups are identified of which the current user is a member. Users may be members of various groups such as organizational groups, volunteer groups, social groups, educational groups, work-related groups, and the like. In the example shown, user's groups 510 include a number of groups including Group “A” 511 (e.g., an organizational group), Group “B” 512 (e.g., a social group), through Group “N” 514 (e.g., a work-related group). The list of groups of which the user is a member is displayed at step 515 using an appropriate user interface, such as a combo box control. At step 520, the user selects one of the groups that the user wishes to associate with search activities. If the user is working and performing work-related searches, then a work-related or organizational group might be selected. However, if the user is performing a leisure or recreational search then a group, such as a social organization, might be selected. At step 525, the user searches on one or more search terms. At step 530, the search term entered by the user is compared to searches previously performed by one or more members of the selected group in order to aggregate and surface the selected group search data to enhance the search that is performed. In one embodiment, the user's historical search data (data store 540) is used for further comparison with the search term in order to further aggregate and surface the previous search activities performed by the user in order to more fully enhance the search. At step 550, the enhanced search results are displayed to the user on a display screen. The search results, returned from a search engine, are enhanced using the group search data and, in one embodiment, the user's historical search data. At step 560, the user acts on the displayed results by selecting a link or selecting an additional search facet, such as a narrowing term identified in either the historical group search data or in the historical user search data, that was previously used to narrow the search terms.

A decision is made as to whether the user has requested that the search session (search terms and subsequent search actions) be shared with the identified group (decision 570). If the user has requested that the search session be shared with the group, then decision 570 branches to the “yes” branch whereupon, at step 575, the user's search terms and subsequent actions are stored in the selected group data store. In this manner, the user's search terms and subsequent actions can be used by others in the group when performing the same or similar search. On the other hand, if the user does not wish to share activities of the search session, then decision 570 branches to the “no” branch bypassing step 575.

At step 580, the search terms and subsequent search actions (e.g., further narrowing search requests, links selected, etc.) are stored in the user's historical data (data store 540) for subsequent retrieval and usage. Processing of the user's search thereafter ends at 595.

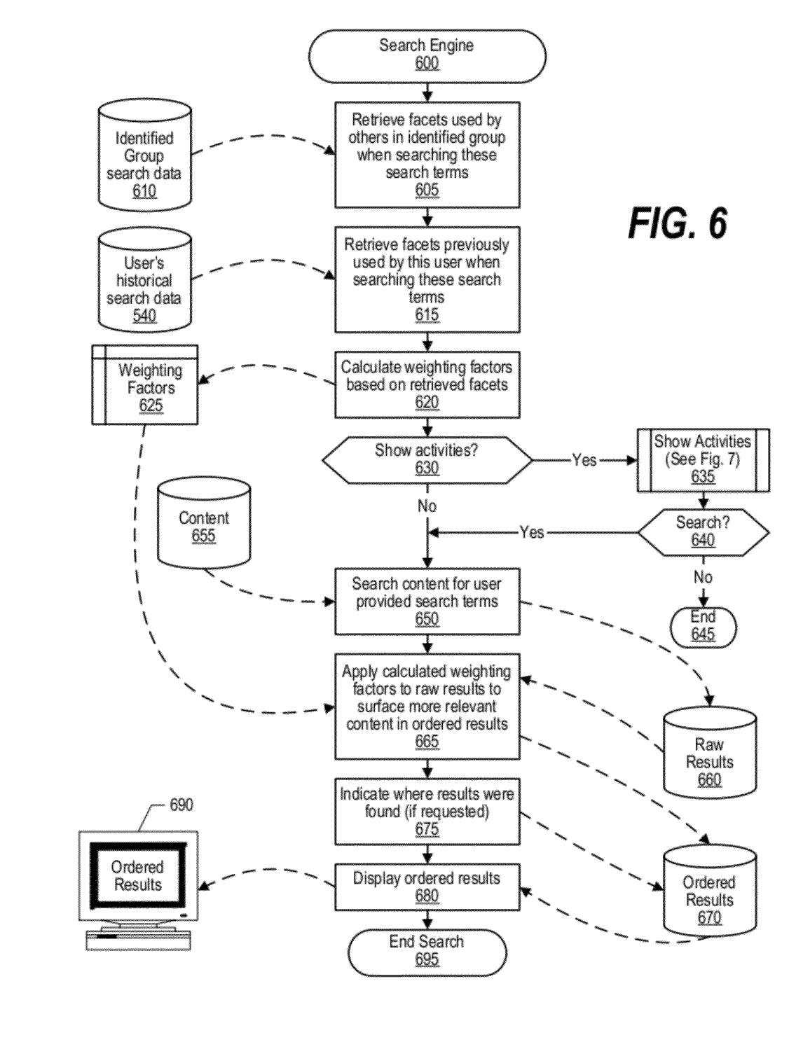

FIG. 6 is a flowchart showing steps taken by a search engine process to utilize group-specific data. Search engine processing commences at 600 whereupon, at step 605, search data (facets, previous links, narrowing terms, etc.) are retrieved from identified group search data store 610 which was previously selected from the list of user groups 510 shown in FIG. 5. The facets received at step 605 are based on other members in the selected group searching the same or similar search terms. In one embodiment, at step 615, search data (facets, previous links, narrowing terms, etc.) are retrieved from user's historical search data (data store 540) based on previous search sessions when the user searched the same or similar search terms. At step 620, weighting factors are computed based on the received facets corresponding to previous searches conducted by other group members and, in one embodiment, previous searches conducted by this user. These weighting factors are stored in memory area 625.

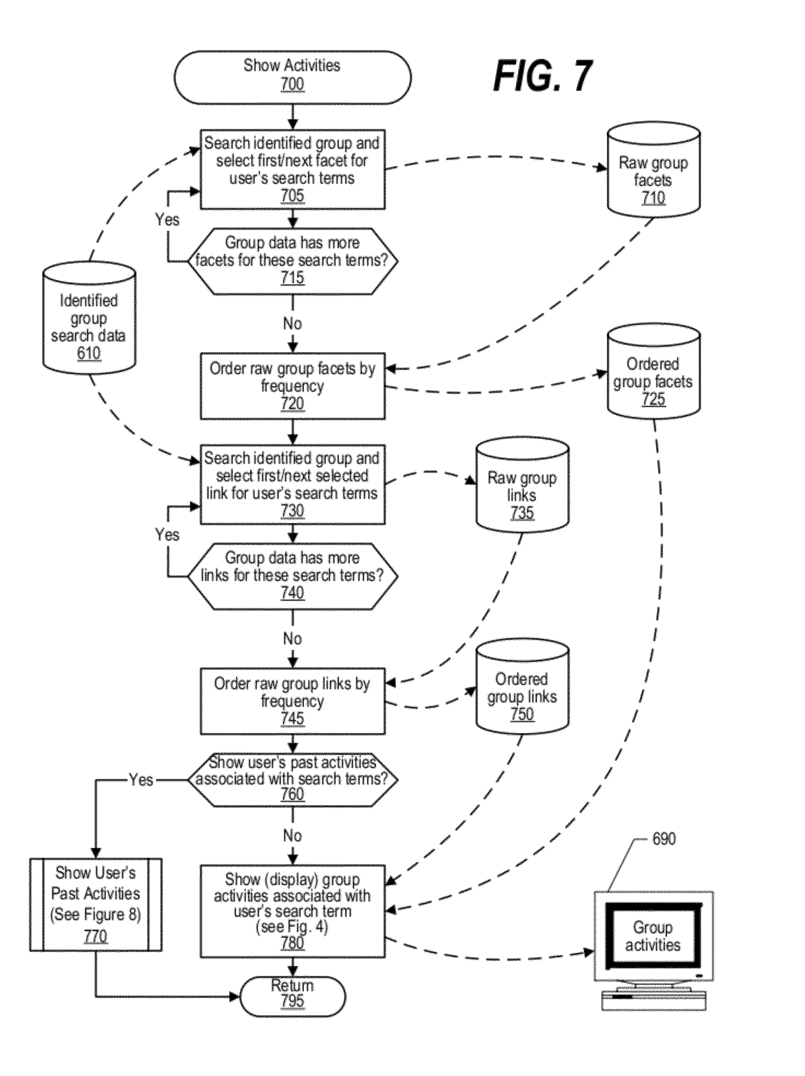

A decision is made as to whether the user has requested to display the retrieved historical search activities that were previously performed by other members of the group and, in one embodiment, the current user (decision 630). If the user has requested for the activities to be displayed, then decision 630 branches to the “yes” branch whereupon, at predefined process 635, the activities are displayed to the user and the user is able to select (act upon) the previous activities (see FIG. 7 and corresponding text for processing details). After the activities have been shown to the user in predefined process 635, a decision is made as to whether the user has requested a search be performed by the search engine (decision 640). For example, during predefined process 635 the user may have selected an additional search term based upon previous search terms that had been used by the group. In this case, the additional search term would be added to the search terms when the search engine searches content 655 at step 650. If the user did not request a search after predefined process 635 (e.g., the user instead selected a link that was identified as previously being used when another member of the group performed a similar search so additional searching is not necessary), at which point decision 640 branches to the “no” branch whereupon search processing ends at 645. On the other hand, if a search has been requested, then decision 640 branches to the “yes” branch for further processing.

The search engine is used to search content 655 at step 650 using the search terms provided by the user. Note that if the user requested to show activities causing predefined process 635 to be executed, additional narrowing search terms may have been added to the user's original search term. The search engine stores the results of the search in raw results data store 660. At step 665, the calculated weighting factors are retrieved from memory area 625 and applied to raw results 660 in order to highlight (e.g., surface) more relevant content based upon previous searches conducted by other members of the group and, in one embodiment, previous searches conducted by this user. The ordered (surfaced) results of step 665 are stored in ordered results data store 670. In one embodiment, the user can request an indicator be displayed to indicate where various results were found. At step 675, this indicator is added to ordered results 670. For example, if a result was surfaced to the top of the ordered results based on several other group members finding the result useful (indicated by the other members selecting the result), then the indicator would show that other group members found the result particularly useful. In a further embodiment, the indicator can include a number that shows the number of group members that selected each of the displayed results. Other indicators can be used to indicate which results the individual user previously selected when performing the same or similar search and this indicator can also show the number of times the user selected a particular link. Results (links) that were selected by more group members and/or more times by the current user are surfaced to the top of the displayed list and appear before results that were selected less often. At step 680, the ordered results are displayed on display device 690. Search processing thereafter ends at 695.

FIG. 7 is a flowchart showing steps performed in order to show a user search activities performed by other members of a group. The show activities process is called from FIG. 6, predefined process 635. Show activities processing commences at 700 whereupon, at step 705, identified group search data 610 is searched for the same or similar search terms requested by the user. When a same or similar search term is found, one or more facets associated with the term are retrieved from group search data store 610 and stored in raw group facets 710. Facets can include narrowing search terms that were entered by other group members to drill down into the results of the search term or other search activities that were performed that were associated with the same or similar search terms. A decision is made as to whether the group data has more facets that correspond to the search terms (decision 715). If the group search data has more facets corresponding to the search terms, then decision 715 branches to the “yes” branch which loops back to retrieve the next facet and store it in raw group facets data store 710. This looping continues until all of the search facets corresponding to the search terms have been identified and retrieved, at which point decision 715 branches to the “no” branch and processing continues. At step 720, the raw group facets are ordered (sorted) based on the frequency that the facet was encountered and stored in ordered group facets 725. Facets occurring more frequently are surfaced toward the top of the list. For example, if a particular term was frequently used to narrow the search term then this narrowing term would be surfaced towards the top in order to highlight the particular term.

At step 730, identified group search data 610 is searched for the same or similar search terms requested by the user. When a same or similar search term is found, one or more links previously selected by one or more group members that was associated with the term are retrieved from group search data store 610 and stored in raw group links 735. Links are the actual network locations (e.g., URLs) that were selected by one or more group members when performing the same or similar search. A decision is made as to whether the group data has more links that correspond to the search terms (decision 740). If the group search data has more links corresponding to the search terms, then decision 740 branches to the “yes” branch which loops back to retrieve the next link and store it in raw group links data store 735. This looping continues until all of the links corresponding to the search terms have been identified and retrieved, at which point decision 740 branches to the “no” branch and processing continues. At step 745, the raw group links are ordered (sorted) based on the frequency that the link was selected by one of the members of the group and stored in ordered group links 750. Links occurring more frequently are surfaced toward the top of the list. For example, if a particular link was frequently selected by various members of the group, then this popular link would be surfaced towards the top in order to highlight the link.

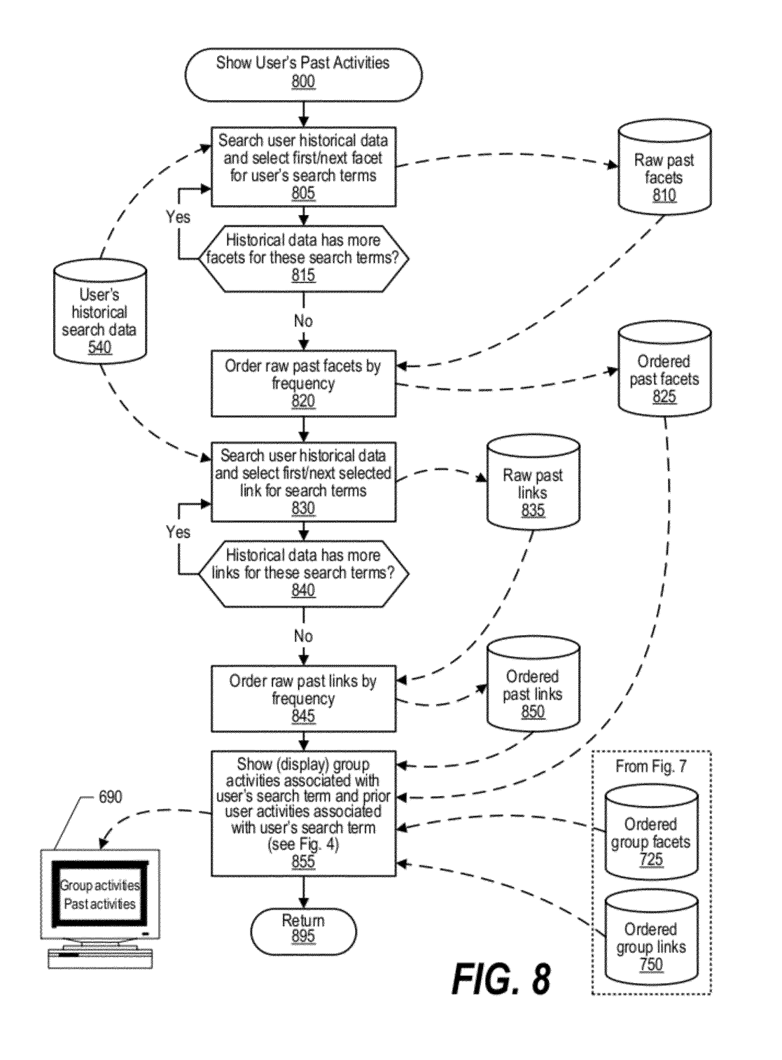

A decision is made as to whether the user has requested to show the user's past activities associated with the search terms (decision 760). If the user has requested to show the user's past activities associated with the search terms, then decision 760 branches to the “yes” branch whereupon, at predefined process 770 the user's past activities are shown (see FIG. 8 and corresponding text for processing details). On the other hand, if the user has not requested that the user's past activities associated with the search terms be shown, then decision 760 branches to the “no” branch whereupon, at step 780, the group activities associated with the search term are retrieved from ordered group facets 725 and ordered group links 750 and displayed on display device 690 (see FIG. 4 for an example). The user can select one of the displayed search facets (e.g., a narrowing search term) and this term will be used during the search processing shown in FIG. 6. The user can, instead, select one of the displayed links in which case the corresponding webpage will be displayed without the need to perform an actual search. Processing then returns to the calling routine (see FIG. 6) at 795.

FIG. 8 is a flowchart showing steps performed in order to show a user search activities previously performed by the user. Show activities processing commences at 800 whereupon, at step 805, the user's historical search data (data store 540) is searched for the same or similar search terms requested by the user. When a same or similar search term is found, one or more facets associated with the term are retrieved from user search data store 540 and stored in raw past facets 810. Facets can include narrowing search terms that were previously entered by the user to drill down into the results of the search term or other search activities that were performed that were associated with the same or similar search terms. A decision is made as to whether the user's historical data has more facets that correspond to the search terms (decision 815). If the user's historical search data has more facets corresponding to the search terms, then decision 815 branches to the “yes” branch which loops back to retrieve the next facet and store it in raw past facets data store 810. This looping continues until all of the search facets corresponding to the search terms have been identified and retrieved, at which point decision 815 branches to the “no” branch and processing continues. At step 820, the raw past facets are ordered (sorted) based on the frequency that the facet was encountered and stored in ordered past facets 825. Facets occurring more frequently are surfaced toward the top of the list. For example, if a particular term was frequently used by the user to narrow the search term then this narrowing term would be surfaced towards the top in order to highlight the particular term.

At step 830, user's historical data 540 is searched for the same or similar search terms requested by the user. When a same or similar search term is found, one or more links previously selected the user are retrieved from user's historical data store 540 and stored in raw past links 835. Links are the actual network locations (e.g., URLs) that were selected by the user when previously performing the same or similar search. A decision is made as to whether the user's historical data has more links that correspond to the search terms (decision 840). If the user's historical data has more links corresponding to the search terms, then decision 840 branches to the “yes” branch which loops back to retrieve the next link and store it in raw past links data store 835. This looping continues until all of the links corresponding to the search terms have been identified and retrieved, at which point decision 840 branches to the “no” branch and processing continues. At step 845, the raw past links are ordered (sorted) based on the frequency that the link was previously selected by the user and stored in ordered group links 850. Links occurring more frequently are surfaced toward the top of the list. For example, if a particular link was frequently selected by the user, then this popular link would be surfaced towards the top in order to highlight the link.

At step 855, the group activities (ordered group facets 725 and ordered group links 750) previously identified in FIG. 7 are retrieved along with ordered past facets 825 and ordered past links 850. The activities (group and user) associated with the search term are displayed on display device 690. See FIG. 4 for an example of displayed activities. The user can select one of the displayed group or user historical search facets (e.g., a narrowing search term) and this term will be used during the search processing shown in FIG. 6. The user can, instead, select one of the displayed group or user historical links in which case the corresponding webpage will be displayed without the need to perform an actual search. Processing then returns to the calling routine (see FIG. 7) at 895.

One of the implementations of the invention is a software application, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive). Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A method comprising:
receiving a search request from a user, the search request including one or more search terms;
identifying the user as a member of a common group of users, the common group of users being a subset of a plurality of search engine users;
retrieving a first plurality of search results based on the search request;
refining the first plurality of search results into a second plurality of search results by comparing at least one of the one or more search terms to a plurality of previously captured search data corresponding to the common group of users; and
displaying the second plurality of search results on a display device.

2. The method of claim 1 further comprising:
aggregating the one or more search terms with the plurality of previously captured search data into an aggregated search data, the aggregated search data being accessible by the common group of users.

3. The method of claim 1 further comprising:
visually highlighting a subset of the second plurality of search results, the subset including one or more of the second plurality of search results.

4. The method of claim 3 wherein visually highlighting further comprises:
surfacing the subset of the second plurality of search results so that the subset visually appears before other results included in the second plurality of search results.

5. The method of claim 3 wherein visually highlighting further comprises:
listing the subset of the second plurality of search results based on the subset being previously selected by one or more of the common group of users, wherein the listing is ordered so that results that were more often selected appear before results that were less often selected.

6. The method of claim 1 further comprising:
retrieving a historical search data of the user, the historical search data includes a plurality of user historical search terms previously entered by the user and a plurality of user historical search actions previously requested by the user, wherein the user historical search actions are associated with the user historical search terms;
comparing the one or more search terms to the plurality of user historical search terms to identify a subset of the plurality of user historical search actions; and
displaying the subset of the plurality of user historical search actions on the display device.

7. The method of claim 6 further comprising:
identifying one or more group-based facets based on comparison of the at least one search term to the plurality of previously captured search data corresponding to the common group of users;
identifying one or more user-based facets based on comparison of the one or more search terms to the plurality of user historical search terms; and
calculating one or more weighting factors based on the one or more group-based facets and the one or more user-based facets,
wherein refining the first plurality of search results into the second plurality of search results further comprises applying the one or more weighting factors to the first plurality of search results.

8. An information handling system comprising:
one or more processors;
a memory coupled to at least one of the processors;
a display device coupled to at least one of the processors;
a network adapter that connects the information handling system to a computer network;
a set of computer program instructions stored in the memory and executed by at least one of the processors in order to perform actions of:
receiving a search request from a user, the search request including one or more search terms;
identifying the user as a member of a common group of users, the common group of users being a subset of a plurality of search engine users;
retrieving a first plurality of search results based on the search request;
refining the first plurality of search results into a second plurality of search results by comparing at least one of the one or more search terms to a plurality of previously captured search data corresponding to the common group of users; and
displaying the second plurality of search results on the display device.

9. The information handling system of claim 8 wherein the processors perform additional actions comprising:
aggregating the one or more search terms with the plurality of previously captured search data into an aggregated search data, the aggregated search data being accessible by the common group of users.

10. The information handling system of claim 8 wherein the processors perform additional actions comprising:
visually highlighting a subset of the second plurality of search results, the subset including one or more of the second plurality of search results.

11. The information handling system of claim 10 wherein visually highlighting includes additional actions comprising:
surfacing the subset of the second plurality of search results so that the subset visually appears before other results included in the second plurality of search results.

12. The information handling system of claim 10 wherein visually highlighting includes additional actions comprising:
listing the subset of the second plurality of search results based on the subset being previously selected by one or more of the common group of users, wherein the listing is ordered so that results that were more often selected appear before results that were less often selected.

13. The information handling system of claim 8 wherein the processors perform additional actions comprising:
retrieving a historical search data of the user, the historical search data includes a plurality of user historical search terms previously entered by the user and a plurality of user historical search actions previously requested by the user, wherein the user historical search actions are associated with the user historical search terms;
comparing the one or more search terms to the plurality of user historical search terms to identify a subset of the plurality of user historical search actions; and
displaying the subset of the plurality of user historical search actions on the display device.

14. The information handling system of claim 13 wherein the processors perform additional actions comprising:
identifying one or more group-based facets based on comparison of the at least one search term to the plurality of previously captured search data corresponding to the common group of users;
identifying one or more user-based facets based on comparison of the one or more search terms to the plurality of user historical search terms; and
calculating one or more weighting factors based on the one or more group-based facets and the one or more user-based facets,
wherein refining the first plurality of search results into the second plurality of search results further comprises applying the one or more weighting factors to the first plurality of search results.

15. A computer program product stored in a computer readable medium, comprising functional descriptive material that, when executed by an information handling system, causes the information handling system to perform actions comprising:
receiving a search request from a user, the search request including one or more search terms;
identifying the user as a member of a common group of users, the common group of users being a subset of a plurality of search engine users;
retrieving a first plurality of search results based on the search request;
refining the first plurality of search results into a second plurality of search results by comparing at least one of the one or more search terms to a plurality of previously captured search data corresponding to the common group of users; and
displaying the second plurality of search results on a display device.

16. The computer program product of claim 15 wherein the information handling system performs further actions comprising:
aggregating the one or more search terms with the plurality of previously captured search data into an aggregated search data, the aggregated search data being accessible by the common group of users.

17. The computer program product of claim 15 wherein the information handling system performs further actions comprising:
visually highlighting a subset of the second plurality of search results, the subset including one or more of the second plurality of search results.

18. The information handling system of claim 17 wherein visually highlighting further includes additional actions comprising:
surfacing the subset of the second plurality of search results so that the subset visually appears before other results included in the second plurality of search results.

19. The information handling system of claim 17 wherein visually highlighting further includes additional actions comprising:
listing the subset of the second plurality of search results based on the subset being previously selected by one or more of the common group of users, wherein the listing is ordered so that results that were more often selected appear before results that were less often selected.

20. The computer program product of claim 15 wherein the information handling system performs further actions comprising:
retrieving a historical search data of the user, the historical search data includes a plurality of user historical search terms previously entered by the user and a plurality of user historical search actions previously requested by the user, wherein the user historical search actions are associated with the user historical search terms;
comparing the one or more search terms to the plurality of user historical search terms to identify a subset of the plurality of user historical search actions; and
displaying the subset of the plurality of user historical search actions on the display device.

21. The computer program product of claim 20 wherein the information handling system performs further actions comprising:
identifying one or more group-based facets based on comparison of the at least one search term to the plurality of previously captured search data corresponding to the common group of users;
identifying one or more user-based facets based on comparison of the one or more search terms to the plurality of user historical search terms; and
calculating one or more weighting factors based on the one or more group-based facets and the one or more user-based facets,
wherein refining the first plurality of search results into the second plurality of search results further comprises applying the one or more weighting factors to the first plurality of search results.

22. A method comprising:
receiving a search request from a user, wherein the search request includes one or more search terms;
identify the user as a member of a common group of users, wherein the common group of users is a subset of a plurality of users of a search engine;
identifying a group historical search data that includes a plurality of group historical search terms previously entered by one or more members of the common group and a plurality of group historical search actions previously requested by the one or more members of the common group, wherein the group historical search actions are associated with the group historical search terms;
comparing the one or more received search terms with the plurality of group historical search terms;
identifying one or more of the group historical search actions based on the comparison;
displaying the one or more identified group historical search actions on a display device;
receiving a search action request from the user, wherein the search action request corresponds to one of the displayed group historical actions; and
executing the received search action request.

23. The method of claim 22 wherein the received search action request is a narrowing search term and wherein the method further comprises:
retrieving, by the search engine, a plurality of search results based on the received search request and the narrowing search term; and
displaying the plurality of search results on the display device.

24. The method of claim 22 wherein the received search action request is a previously selected link and wherein the method further comprises:
requesting a webpage corresponding to the previously selected link; and
displaying the requested webpage on the display device.

25. The method of claim 22 further comprising:
identifying a user search data that includes a plurality of user historical search terms previously entered by the user and a plurality of user historical search actions previously requested by the user, wherein the user historical search actions are associated with the user historical search terms;
comparing the one or more received search terms with the plurality of user historical search terms;
identifying one or more of the user historical search actions based on the comparison;
displaying the one or more identified user historical search actions prior to receiving the search action request, wherein the search action request corresponds to one of the group consisting of the identified group historical search actions and the identified user historical search actions.
